(19) United States
(12) Patent Application Publication
(10) Pub. No.: US 2023/0399985 A1
(43) Pub. Date: Dec. 14, 2023

(54) METHOD FOR KEEPING COMBUSTION OF GAS TURBINE STABLE IN DYNAMIC PROCESS, COMPUTER READABLE MEDIUM, AND GAS TURBINE CONTROL SYSTEM

(71) Applicant: SHANGHAI ADVANCED RESEARCH INSTITUTE, CHINESE ACADEMY OF SCIENCES, Shanghai (CN)

(72) Inventors: Xiaoyi ZHANG, Shanghai (CN); Weiguang HUANG, Shanghai (CN)

(21) Appl. No.: 18/036,162

(22) PCT Filed: Mar. 11, 2021
(86) PCT No.: PCT/CN2021/080289

§ 371 Date: Jun. 19, 2023

(30) Foreign Application Priority Data
Nov. 10, 2020 (CN) 202011249514.2

(51) Int. Cl. F02C 9/28

(52) U.S. Cl. CPC F02C 9/28; F05D 2270/3061

(57) ABSTRACT

The present disclosure provides a method for maintaining stable combustion of a gas turbine during a dynamic process, a computer-readable medium, and a gas turbine control system. The method comprises: compensating a fuel control valve stroke command δ_{f,CLC} with a fuel flow compensation function G_{f,COMP}(s); and compensating a VIGV command θ_{VIGV,CLC} with an air flow compensation function G_{air,COMP}(s), wherein the fuel flow compensation function G_{f,COMP}(s) and the air flow compensation function G_{air,COMP}(s) satisfy the following relation: G_{f,COMP}(s)·G_{f}(s)=G_{air,COMP}(s)·Gₐᵢᵣ(s), and an fuel-to-air ratio is directly proportional to δ_{f,CLC}/θ_{VIGV,CLC} even during the dynamic process, where G_{f}(s) represents an overall transfer function of a fuel channel from a fuel control valve servo system to an inlet of a combustion chamber, and Gₐᵢᵣ(s) represents an overall transfer function of an air channel from a VIGV servo system to the inlet of the combustion chamber.

### FIELD

The present disclosure relates to a gas turbine control system, and in particular to a control method for a gas turbine control system.

### BACKGROUND

The market requirements with regard to the flexibility of gas turbines have been increasing. In addition to normal frequency response, dynamic operations such as fast start-up, load rejection, island-mode operation, and extended frequency response are also often requested by the customers. The stability of the gas turbine during these dynamic operations is becoming more and more important.

In order to reduce NOx emissions, premixed combustion is adopted in modern gas turbines. As shown in FIG. 1, premixed combustion means the spatial separation of two processes: the mixing of fuel and air; the stable chemical reaction of the flammable mixture: the mixing of fuel with air; the stable chemical reaction of the flammable mixture.

The premixed combustion has generally two limits: flame flashback (which typically occurs when too much fuel is present) and flame extinction (which typically occurs when little fuel is present). When combustion condition is close to the two limits, combustion vibration occurs. Premixed flames have usually a much narrower operation range in terms of fuel-to-air ratios as compared to diffusional flames.

As shown in FIG. 2, during the actual operation of a gas turbine, in order to reduce NOx emissions, the combustion is pushed as much as possible to the lean fuel side. From the perspective of gas turbine control, the fuel-to-air ratio has to be more accurately controlled. When a gas turbine is running at a steady state, this can be achieved by controlling the temperature levels. However, when a gas turbine is running at a dynamic state, since the air channel and the fuel channel have different dynamics, it is very difficult to accurately control the fuel-to-air ratio at the inlet of combustion chamber.

This is one of the main reasons that a more than enough margin has to be kept between the operation line and the lean combustion limit. This results in a higher NOx emission. In addition, the difficulty of fuel-to-air ratio control during such a transient process also limits the dynamic performance of the gas turbine.

Therefore, there is a need for a method that can improve the accuracy of the fuel-to-air ratio control for the gas turbine during dynamic process.

### SUMMARY OF THE DISCLOSURE

The present disclosure proposes a new control method applicable to a gas turbine control system. Fuel flow and air flow which enter a combustion chamber are dynamically matched such that the purposes of maintaining stable combustion during a dynamic process and reducing NOx emissions, etc. are achieved.

The present disclosure provides a method for maintaining stable combustion of a gas turbine during a dynamic process. The method comprises:
compensating a fuel control valve stroke instruction δ_{f,CLC} with a fuel flow compensation function G_{f,COMP}(s); and
compensating a VIGV instruction θ_{VIGV,CLC} with an air flow compensation function G_{air,COMP}(s),
wherein the fuel flow compensation function G_{f,COMP}(s) and the air flow compensation function G_{air,COMP}(s) satisfy the following relation:
G_{f,COMP}(s)·G_{f}(s)=G_{air,COMP}(s)·Gₐᵢᵣ(s), and a fuel-to-air ratio is directly proportional to

$$\frac{{δ}_{f , CLC}}{{θ}_{VIGV , C L C}}$$

during the dynamic process,
wherein G_{f}(s) represents an overall transfer function of a fuel channel from a fuel control valve servo system to an inlet of a combustion chamber; and Gₐᵢᵣ(s) represents an overall transfer function of an air channel from a VIGV servo system to the inlet of the combustion chamber.

In one embodiment, the method comprises:
the fuel mass flow at the inlet of the combustion chamber being represented by \dot{m}_{f}=G_{f,COMP}(s)·K_{V}G_{f}(s)·δ_{f,CLC}, where K_{V} is a transformation coefficient between the stroke and the flow determined by valve characteristics; and
the air mass flow at the inlet of the combustion chamber being represented by \dot{m}ₐᵢᵣ=G_{air,COMP}(s)·K_{C}Gₐᵢᵣ(s)·θ_{VIGV,CLC}, where K_{C} is a transformation coefficient between the VIGV angle and the mass flow of an air compressor.

In one embodiment, the fuel-to-air ratio is:

$$\frac{{\dot{m}}_{f}}{{\dot{m}}_{air}} = \frac{{G}_{f , COMP} ( s ) \cdot {K}_{V} {G}_{f} ( s ) \cdot {δ}_{f , CLC}}{{G}_{air , C O M P} ( s ) \cdot {K}_{C} {G}_{air} ( s ) \cdot {θ}_{VIGV , C L C}} = \frac{{K}_{V} {δ}_{f , CLC}}{{K}_{C} {θ}_{VIGV , C L C}}$$

In one embodiment, the method further comprises:
adding an additional compensator G_{ACCEL} on the fuel channel and the air channel to accelerate the combustion process and improve the response of the fuel channel is and the air channel;
the fuel mass flow at the inlet of the combustion chamber being represented by \dot{m}_{f}=G_{ACCEL}·G_{f,COMP}(s)·K_{V}G_{f}(s)·δ_{f,CLC}; and
the air mass flow at the inlet of the combustion chamber being represented by \dot{m}ₐᵢᵣ=G_{ACCEL}·G_{air,COMP}(s)·K_{C}Gₐᵢᵣ(s)·θ_{VIGV,CLC}.

In one embodiment, the compensator G_{ACCEL} is:

$${G}_{A C C E L} = \frac{1 + {t}_{1} s}{1 + {t}_{2} s} ;$$

where t₁ and t₂ are time constants, and t₁>t₂; and s represents a complex variable of the Laplace transform.

In one embodiment, when only the air channel is compensated to match the dynamic characteristics of the fuel channel, the fuel flow compensation function is G_{f,COMP}(s)=1, and the air flow compensation function is

$${G}_{air , COMP} ( s ) = \frac{{G}_{f} ( s )}{{G}_{air} ( s )} .$$

In one embodiment, when only the fuel channel is compensated to match the dynamic characteristics of the air channel, the air flow compensation function is G_{air,COMP}(s)=1, and the fuel flow compensation function is

$${G}_{f , COMP} ( s ) = \frac{{G}_{air} ( s )}{{G}_{f} ( s )} .$$

In one embodiment, the fuel channel comprises a fuel gas channel and a fuel oil channel, and during a fuel gas operation and a fuel oil operation, the fuel control valve stroke command δ_{f,CLC} is compensated as follows:

G_{f_g,COMP}(s)·G_{f_g}(s)=G_{air,COMP}(s)·Gₐᵢᵣ(s)

G_{f_o,COMP}(s)·G_{f_o}(s)=G_{air,COMP}(s)·Gₐᵢᵣ(s)
wherein the transfer function for the fuel gas channel is G_{f_g}(s), and the transfer function for the fuel oil channel is G_{f_o}(s).

The present disclosure further provides a computer-readable medium storing computer instructions, wherein when the computer instructions are executed, the method for maintaining stable combustion of a gas turbine during a dynamic process is performed.

The present disclosure further provides a gas turbine control system, comprising a memory and a processor, wherein the memory stores computer instructions executable on the processor, and when the processor executes the computer instructions, the method for maintaining stable combustion of a gas turbine during a dynamic process is performed.

### BRIEF DESCRIPTION OF THE DRAWINGS

The forgoing summary of the present disclosure and the following detailed description of embodiments of the present disclosure will be better understood when read in conjunction with the accompanying drawings. It should be noted that the drawings are merely examples of the claimed disclosure. In the figures, the same reference signs represent the same or similar elements.

FIG. 1 illustrates two processes of premixed combustion;

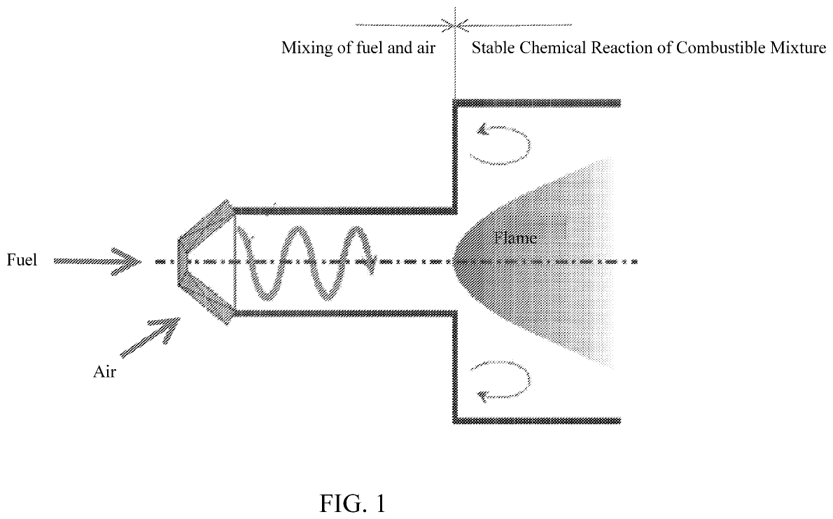

FIG. 2 illustrates dynamic characteristics of an air channel and a fuel channel during a dynamic operation of a gas turbine;

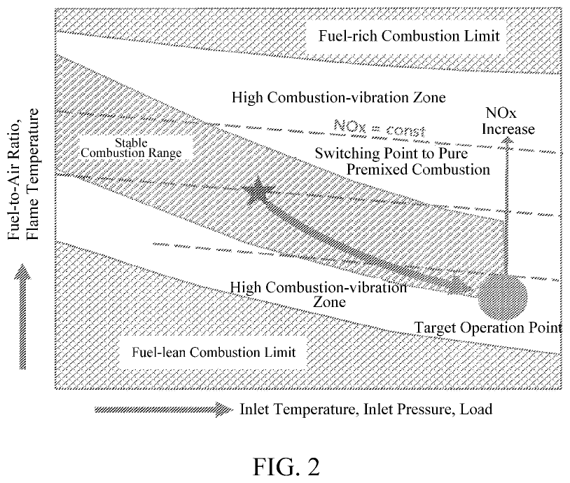

FIG. 3 illustrates a gas turbine control system according to one embodiment of the present disclosure;

FIG. 4 illustrates a schematic diagram of transfer functions of the fuel channel and the air channel according to one embodiment of the present disclosure;

FIG. 5 illustrates a schematic diagram of transfer functions of the entire system after compensation for a fuel control valve command δ_{f,CLC} and a VIGV angle command θ_{VIGV,CLC} according to one embodiment of the present disclosure;

FIG. 6 is a simplified diagram of FIG. 5;

FIG. 7 illustrates a gas turbine control system having a compensator according to one embodiment of the present disclosure;

FIG. 8 illustrates a fuel-to-air flow ratio without compensation; and

FIG. 9 illustrates a fuel-to-air flow ratio with a compensator according to one embodiment of the present disclosure.

### DETAILED DESCRIPTION OF EMBODIMENTS

The detailed features and advantages of the present disclosure will be described in detail below in the detailed description of embodiments. The content is sufficient to enable those skilled in the art to understand the technical scheme of the present disclosure and implement it accordingly, and the related objectives and advantages of the present disclosure can be readily appreciated for those skilled in the art from the description, the claims, and the accompanying drawings disclosed in the present specification.

In order to ensure stable combustion and reduce NOx emissions during a dynamic process, it is necessary to accurately control the ratio of fuel flow to air flow which enters the combustion chamber. However, there is difficulty in practice because the air channels and fuel channels have different dynamic characteristics. The present disclosure discloses a new control method that can improve the fuel-to-air ratio control at an inlet of a combustor (or a burner) during the dynamic process.

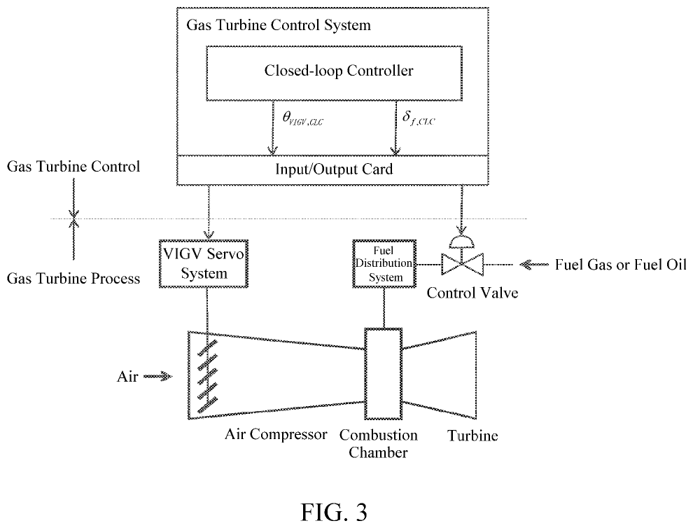

FIG. 3 illustrates a gas turbine control system according to one embodiment of the present disclosure. A gas turbine is composed of an air compressor, a combustion chamber, and a turbine. Air is compressed by the air compressor, mixed with fuel in the combustion chamber for combustion, and then expands to do work in the turbine. The air flow, or the air mass flow, is adjusted by variable inlet guide vane (VIGV) at an inlet of the air compressor. The fuel flow, or the fuel mass flow, is adjusted by a fuel control valve on a fuel delivery pipe. A variable inlet guide vane (VIGV) servo system and the fuel control valve are controlled based on an electrical signal received from the gas turbine control system. An input/output card is configured to convert a digital signal into the electrical signal. The digital signal includes, but is not limited to, a fuel control valve stroke command δ_{f,CLC} and a VIGV angle command δ_{VIGV,CLC} As shown in FIG. 3, the fuel control valve stroke command δ_{f,CLC} is generated in a closed-loop controller. The VIGV angle command δ_{VIGV,CLC} is also calculated in the closed-loop controller.

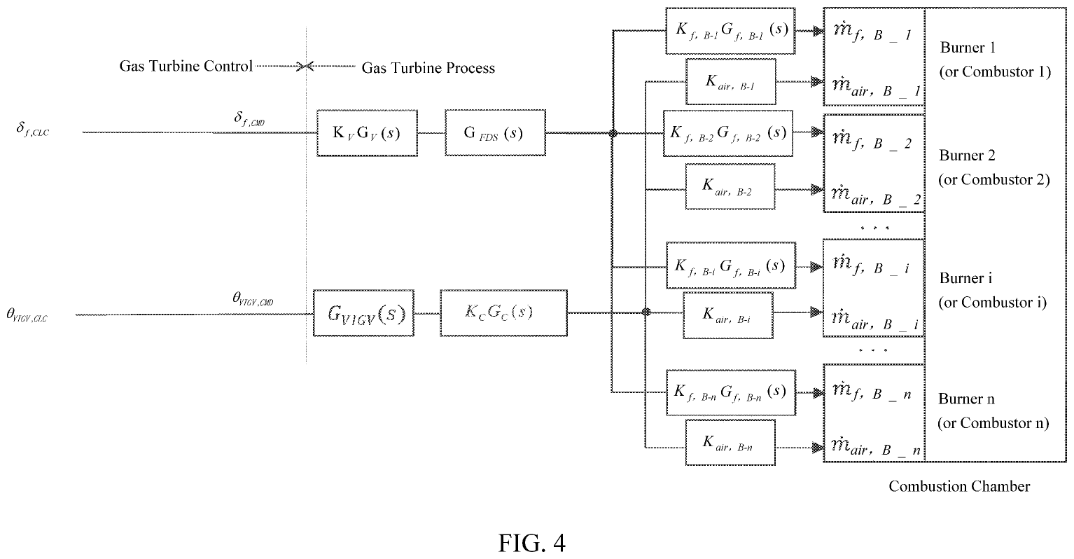

As shown in FIG. 4, the fuel control valve stroke command δ_{f,CLC} and the fuel mass flow \dot{m}_{f,B-i} that enters the i-th burner (referred to as burner i) or the i-th combustor (referred to as combustor i) in the combustion chamber have the relation as follows:

\dot{m}_{f,B-i}=K_{V}G_{V}(s)·G_{FDS}(s)·K_{f,B-i}G_{f,B-i}(s)·δ_{f,CLC}
where K_{V} is a transformation coefficient between the stroke and the flow, determined by valve characteristics; G_{V}(s) denotes the dynamic characteristics of the valve servo; G_{FDS}(s) denotes a transfer function of a fuel distribution system; and K_{f,B-i} denotes the ratio of Burner i fuel mass flow to the total fuel mass flow. G_{f,B-i}(s) is a transfer function of a fuel branch pipe before the Burner i. s denotes a complex variable of the Laplace transform.

Also as shown in FIG. 4, the variable inlet guide vane (VIGV) angle command θ_{VIGV,CLC} and the air mass flow \dot{m}_{air,B-i} that enters Burner i have the relation as follows:

\dot{m}_{air,B-i}=G_{VIGV}(s)·K_{C}G_{C}(s)·K_{air,B-i}·θ_{VIGV,CLC}
where G_{VIGV}(s) is the transfer function of the VIGV servo. K_{C} is the transformation coefficient between the VIGV angle and the mass flow of the air compressor. G_{C}(s) is the transfer function of the dynamic characteristics of the air compressor. K_{air,B-i} is the ratio of Burner I air mass flow to the total air mass flow.

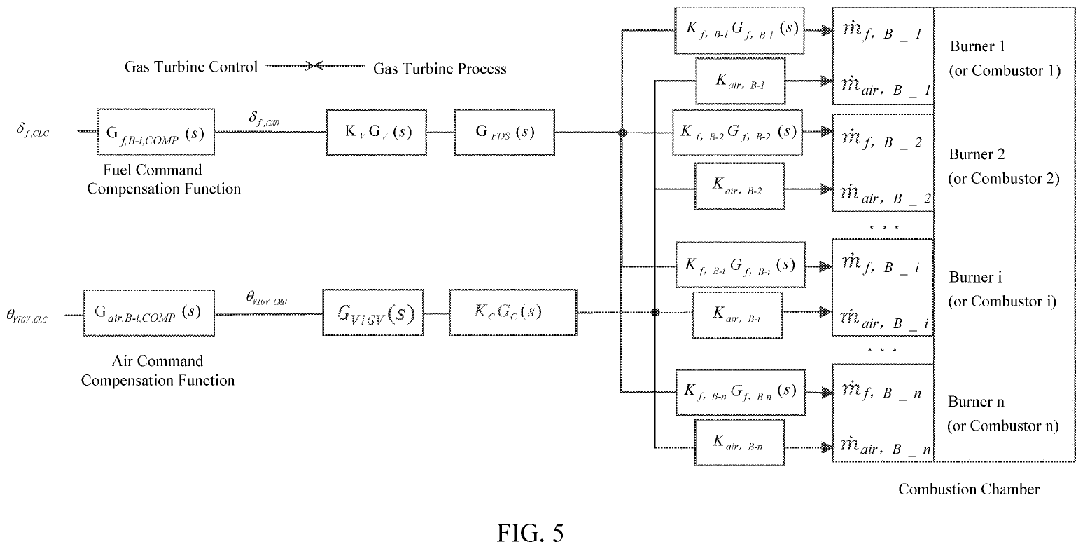

From the above two equations, it can be seen that the fuel channel and the air channel have different dynamic characteristics (different transfer functions). As shown in FIG. 5, a compensator can be added after the fuel control valve strole command f,CLC and the VIGV angle command δ_{VIGV,CLC} wherein the compensator is realized through a fuel command compensation function and an air command compensation function. The fuel command compensation function G_{f,B-i,COMP}(s) is added for the fuel channel of burner i, and the air command compensation function G_{air,B-i,COMP}(s) is added for the air channel.

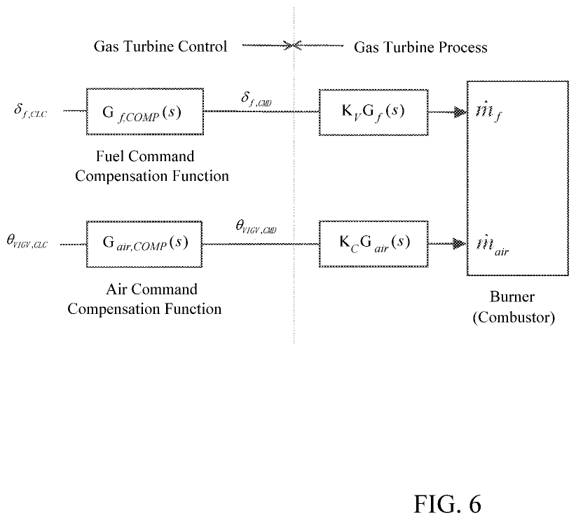

The compensator in FIG. 5 is designed for burner i. In practice, only one combustor can be selected for compensation. The combustor may be the most critical combustor, or may be a virtual average combustor. With the burner to be compensated already selected, FIG. 5 can be simplified to FIG. 6. The above two equations can also be simplified as follows:

\dot{m}_{f}=G_{f,COMP}(s)·K_{V}G_{f}(s)·δ_{f,CLC}

\dot{m}ₐᵢᵣ=G_{air,COMP}(s)·K_{C}Gₐᵢᵣ(s)·θ_{VIGV,CLC}
where G_{f,COMP}(s) is the compensator added to the fuel control valve stroke command, and G_{f}(s) is the overall transfer function of the fuel channel from the control valve to the inlet of the burner (or the combustor). G_{air,COMP}(s) is the compensator added to the VIGV angle command, and Gₐᵢᵣ(s) is the overall transfer function of the air channel from the VIGV servo system to the inlet of the burner.

Depending on the purpose, the two compensators can be designed in different ways. For example, in order to ensure that the dynamic behavior of the fuel-to-air ratio at the inlet of the combustion chamber is as designed, the two compensators can be designed in a way to fulfill the following relation:

G_{f,COMP}(s)·G_{f}(s)·G_{air,COMP}(s)·Gₐᵢᵣ(s)

The compensator is introduced for the purpose as follows.

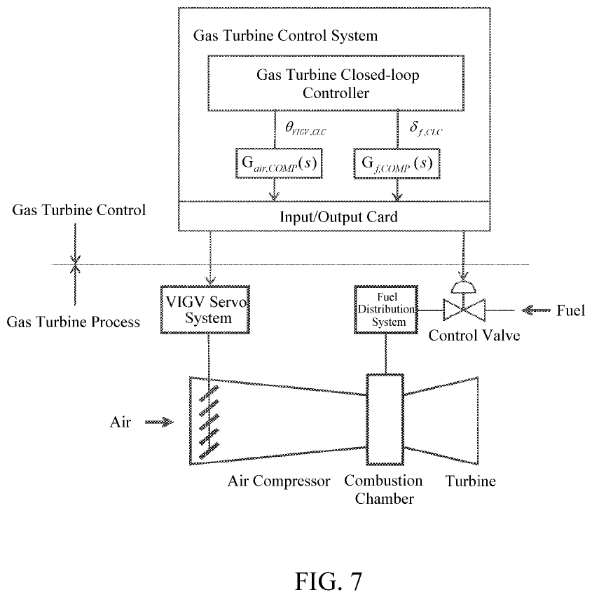

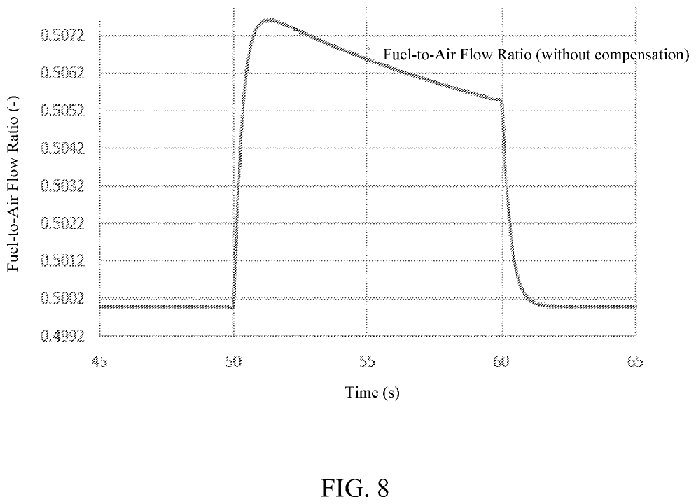

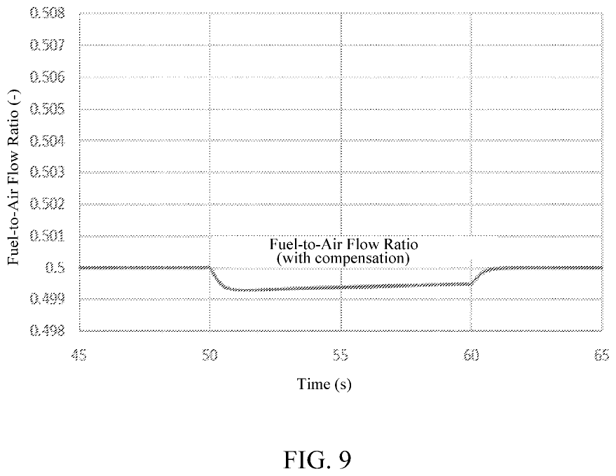

As shown in FIG. 7, it is considered to increase the fuel mass flow and the air mass flow linearly to keep the fuel-to-air flow ratio constant. Although the fuel control valve stroke command and VIGV angle command can be correctly generated in the closed-loop controller to linearly increase the fuel mass flow and the air mass flow, the actual fuel-to-air flow ratio at the inlet of the combustion chamber fluctuates as shown in FIG. 8. This is because the fuel channel and the air channel have different dynamic characteristics (transfer functions). For example, the maximum fuel-to-air flow ratio is 0.5076, which is 0.076 higher than is 0.5. This is equivalent to a fluctuation of about 22° C. in the flame temperature, which is enough to cause the combustion stability problem. By using the compensators disclosed in the present disclosure, the fuel-to-air flow ratio can be reduced as shown in FIG. 9. It should be noted that the compensator cannot be perfect, and a small fluctuation may still exist.

The specific embodiments of the present disclosure are implemented in a straightforward way. As shown in FIG. 7, the fuel control valve stroke command δ_{f,CLC} is compensated with the fuel flow compensator G_{f,COMP}(s) before being sent to the input/output card. Similarly, the VIGV command θ_{VIGV,CLC} is compensated with the air flow compensator G_{air,COMP}(s) before being sent to the input/output card. The two compensators can be implemented directly into the gas turbine control system in the form of programs.

For the specific design for the compensators, reference can be made to the description below.

The transfer function of the fuel channel from the fuel control valve to the inlet of the combustor (or the burner) is different from the transfer function of the air channel from the VIGV to the inlet of the combustor (or the burner). As shown in FIG. 6, the control valve stroke command and the VIGV angle command can be compensated. As a result, the fuel mass flow and the air mass flow at the inlet of the combustor (or burner) can be respectively calculated using the following formulas:

\dot{m}_{f}=G_{f,COMP}(s)·K_{V}G_{f}(s)·δ_{f,CLC}

\dot{m}ₐᵢᵣ=G_{air,COMP}(s)·K_{C}Gₐᵢᵣ(s)·θ_{VIGV,CLC}

In order to make that the dynamic behavior of the fuel-to-air ratio at the inlet of the combustion chamber is as designed, the two compensators can be designed in a way to fulfill the following relation:

G_{f,COMP}(s)·G_{f}(s)=G_{air,COMP}(s)·Gₐᵢᵣ(s)

Obviously,

$$\frac{{\dot{m}}_{f}}{{\dot{m}}_{air}} = \frac{{G}_{f , COMP} ( s ) \cdot {K}_{V} {G}_{f} ( s ) \cdot {δ}_{f , CLC}}{{G}_{air , C O M P} ( s ) \cdot {K}_{C} {G}_{air} ( s ) \cdot {θ}_{VIGV , C L C}} = \frac{{K}_{V} {δ}_{f , CLC}}{{K}_{C} {θ}_{VIGV , C L C}}$$

since K_{V} and K_{C} are transformation coefficients, the fuel-to-air ratio is directly proportional to

$$\frac{{δ}_{f , CLC}}{{θ}_{VIGV , C L C}}$$

even during the dynamic process.

In one embodiment, only the air channel is compensated to match the dynamic characteristics of the fuel channel, and in this case the compensator can be designed as follows:

$${G}_{f , COMP} ( s ) = 1$$

$${G}_{air , COMP} ( s ) = \frac{{G}_{f} ( s )}{{G}_{air} ( s )}$$

Obviously,

G_{f,COMP}(s)·G_{f}(s)=G_{air,COMP}(s)·Gₐᵢᵣ(s)=G_{f}(s)

In one embodiment, only the fuel channel is compensated to match the dynamic characteristics of the air channel, and in this case the compensator can be designed as follows:

$${G}_{f , COMP} ( s ) = 1$$

$${G}_{air , COMP} ( s ) = \frac{{G}_{f} ( s )}{{G}_{air} ( s )}$$

Obviously,

G_{f,COMP}(s)·G_{f}(s)=G_{air,COMP}(s)·Gₐᵢᵣ(s)=Gₐᵢᵣ(s)

In one embodiment, since fuel gas is compressible while fuel oil is incompressible, the transfer function G_{f_g}(s) of the fuel gas channel is significantly different from the transfer function G_{f_o}(s) of the fuel oil channel. As a result, the control valve stroke command should be compensated differently during the fuel gas operation and the fuel oil operation.

G_{f_g,COMP}(s)·G_{f_g}(s)=G_{air,COMP}(s)·Gₐᵢᵣ(s)

G_{f_o,COMP}(s)·G_{f_o}(s)=G_{air,COMP}(s)·Gₐᵢᵣ(s)

In one embodiment, an additional compensator G_{ACCEL} may also be added to both the fuel channel and the air channel.

\dot{m}_{f}=G_{ACCEL}·G_{f,COMP}(s)·K_{V}G_{f}(s)·δ_{f,CLC}

\dot{m}ₐᵢᵣ=G_{ACCEL}·G_{air,COMP}(s)·K_{C}Gₐᵢᵣ(s)·θ_{VIGV,CLC}

When the fuel channel or the air channel has a relatively large volume, or when the control valve servo and the VIGV servo are relatively slow, the fuel mass flow f and the air mass flow \dot{m}ₐᵢᵣ at the inlet of the combustor have a larger delay than the command in the control system. G_{ACCEL} is designed to accelerate the process and improve the response of the fuel channel and the air channel. For example, G_{ACCEL} can be designed as the transfer function as follows:

$${G}_{A C C E L} = \frac{1 + {t}_{1} s}{1 + {t}_{2} s}$$

where t₁ and t₂ are time constants, and t₁>t₂; and s is a complex variable of the Laplace transform.

As indicated in the present application and the claims, the words “a”, “an” and/or “the” do not refer in particular to the singular but may also include the plural, unless the context clearly indicates an exception. In general, the terms “comprising” and “including” only indicates the inclusion of clearly identified steps and elements, but these steps and elements do not constitute an exclusive list, and a method or a device may also include other steps or elements.

Although the present application makes various references to some modules in the system according to the embodiments of the present application, any number of different modules can be used and operated in the gas turbine control system. The modules are illustrative only, and different modules may be used in different aspects of the system and the method.

Also, in the present application, specific words are used to describe the embodiments of the present application. For instance, the expressions “one embodiment”, “an embodiment” and/or “some embodiments” refer to a certain feature, structure, or characteristic associated with at least one embodiment of the present application. Therefore, it should be emphasized and noted that two or more references to “an embodiment”, “one embodiment”, or “an alternative embodiment” in different places in the present specification do not necessarily refer to the same embodiment. In addition, some of the features, structures, or characteristics of one or more embodiments of the present application can be combined as appropriate.

Further, those skilled in the art can understand that the aspects of the present application may be illustrated and described in terms of several patentable categories or circumstances, including any new and useful process, machine, product or combination of substances, or any new and useful improvements to them. Accordingly, the aspects of the present application may be entirely executed by hardware, or entirely executed by software (including firmware, resident software, microcode, etc.), or executed by a combination of hardware and software. The above hardware or software may be referred to as “data block”, “module”, “engine”, “unit”, “component” or “system”. In addition, the aspects of the present application may be embodied as a computer product, including computer-readable program, on one or more computer-readable media.

A computer-readable signal medium may include a data propagating signal that contains a computer program, for example, on baseband or as part of a carrier. The propagating signal may be in many forms, including electromagnetic form, optical form, etc., or a suitable combination. A computer-readable signal medium may be any computer-readable medium other than a computer-readable storage medium, which can be connected to an instruction executable system, apparatus, or device to communicate, propagate, or transmit a program for use. The program code on a computer-readable signal medium may be transmitted over any suitable medium, including radio, a cable, a fiber optic cable, RF, or the like, or a combination of any of the above media.

The computer program codes required for the operation of the present application can be written in any one or more programming languages, including object-oriented programming languages (such as Java, Scala, Smalltalk, Eiffel, JADE, Emerald, C++, C #, VB.NET, and Python), conventional programming languages (such as C language, Visual Basic, Fortran 2003, Perl, COBOL 2002, PHP, and ABAP), dynamic programming languages (such as Python, Ruby, and is Groovy) or other programming languages. The program codes may entirely run on the user computer, or run on the user computer as an independent software package, or run partly on the user computer and partly on a remote computer, or entirely run on the remote computer or a server. In the latter case, the remote computer can be connected to the user computer through any form of network, such as local area network (LAN) or wide area network (WAN), or connected to an external computer (such as through the Internet), or used in a cloud computing environment, or used as a service, such as Software as a Service (SaaS).

The terms and expressions used herein are for description only, and the present disclosure should not be limited to those terms and expressions. Using those terms and expressions does not mean to exclude any equivalent features shown and described (or partially), and it should be recognized that various modifications may also be included within the scope of the claims. There may also be other modifications, changes, and substitutions. Accordingly, the claims should be considered to cover all such equivalents.

Similarly, it should be noted that, although the present disclosure has been described with reference to the present particular embodiments, the ordinary skilled in the art should appreciate that the forgoing embodiments are only for illustrating purpose, and various equivalent changes or replacements can be made without departing from the spirit of the present disclosure. Therefore, changes and variations to the forgoing embodiments within the spirit of the present disclosure shall all fall within the scope of the claims of the present application.

1. A method for maintaining stable combustion of a gas turbine during a dynamic process, comprising:
compensating a fuel control valve stroke command δ_{f,CLC} with a fuel flow compensation function G_{f,COMP}(s); and
compensating a VIGV command θ_{VIGV,CLC} with an air flow compensation function G_{air,COMP}(s),
wherein the fuel flow compensation function G_{f,COMP}(s) and the air flow compensation function G_{air,COMP}(s) satisfy the following relation:
G_{f,COMP}(s)··G_{f}(s)=G_{air,COMP}(s)·Gₐᵢᵣ(s), and a fuel-to-air ratio is directly proportional to
$$\frac{{δ}_{f , CLC}}{{θ}_{VIGV , C L C}}$$
during the dynamic process,
wherein G_{f}(s) represents an overall transfer function of a fuel channel from a fuel control valve servo system to an inlet of a combustion chamber; and Gₐᵢᵣ(s) represents an overall transfer function of an air channel from a VIGV servo system to the inlet of the combustion chamber.

2. The method for maintaining stable combustion of a gas turbine during a dynamic process of claim 1, comprising:
fuel mass flow at the inlet of the combustion chamber being represented by \dot{m}_{f}=G_{f,COMP}(s)·K_{V}G_{f}(s)·δ_{f,CLC}, wherein K_{V} is a transformation coefficient between the stroke and the flow determined by valve characteristics; and
air mass flow at the inlet of the combustion chamber being represented by
\dot{m}ₐᵢᵣ=G_{air,COMP}(s)·K_{C}Gₐᵢᵣ(s)·θ_{VIGV,CLC} wherein K_{C} is a transformation coefficient between VIGV angle and the mass flow of an air compressor.

3. The method for maintaining stable combustion of a gas turbine during a dynamic process of claim 2, wherein the fuel-to-air ratio is:
$$\frac{{\dot{m}}_{f}}{{\dot{m}}_{air}} = \frac{{G}_{f , COMP} ( s ) \cdot {K}_{V} {G}_{f} ( s ) \cdot {δ}_{f , CLC}}{{G}_{air , C O M P} ( s ) \cdot {K}_{C} {G}_{air} ( s ) \cdot {θ}_{VIGV , C L C}} = \frac{{K}_{V} {δ}_{f , CLC}}{{K}_{C} {θ}_{VIGV , C L C}} .$$

4. The method for maintaining stable combustion of a gas turbine during a dynamic process of claim 1, further comprising:
adding an additional compensator G_{ACCEL} to the fuel channel and the air channel to accelerate the gas turbine process and improve responsiveness of the fuel channel and the air channel;
the fuel mass flow at the inlet of the combustion chamber being represented by \dot{m}_{f}=G_{ACCEL}·G_{f,COMP}(s)·K_{V}G_{f}(s)·δ_{f,CLC}; and
the air mass flow at the inlet of the combustion chamber being represented by \dot{m}ₐᵢᵣ=G_{ACCEL}·G_{air,COMP}(s)·K_{C}Gₐᵢᵣ(s)·θ_{VIGV,CLC}.

5. The method for maintaining stable combustion of a gas turbine during a dynamic process of claim 4, wherein the compensator G_{ACCEL} is:
$${G}_{A C C E L} = \frac{1 + {t}_{1} s}{1 + {t}_{2} s} ;$$
wherein t₁ and t₂ are time constants, and t₁>t₂; and s is a complex variable of the Laplace transform.

6. The method for maintaining stable combustion of a gas turbine during a dynamic process of claim 1, wherein when only the air channel is compensated to match dynamic characteristics of the fuel channel, the fuel flow compensation function is G_{f,COMP}(s)=1, and the air flow compensation function is
$${G}_{air , COMP} ( s ) = \frac{{G}_{f} ( s )}{{G}_{air} ( s )} .$$

7. The method for maintaining stable combustion of a gas turbine during a dynamic process of claim 1, wherein when only the fuel channel is compensated to match the dynamic characteristics of the air channel, the air flow compensation function is G_{air,COMP}(s)=1, and the fuel flow compensation function is
$${G}_{f , COMP} ( s ) = \frac{{G}_{air} ( s )}{{G}_{f} ( s )} .$$

8. The method for maintaining stable combustion of a gas turbine during a dynamic process of claim 1, wherein the fuel channel comprises a fuel gas channel and a fuel oil channel, and during a fuel gas operation and a fuel oil operation, the fuel control valve stroke command δ_{f,CLC} is compensated as follows:
G_{f_g,COMP}(s)·G_{f_g}(s)=G_{air,COMP}(s)·Gₐᵢᵣ(s)
G_{f_o,COMP}(s)·G_{f_o}(s)=G_{air,COMP}(s)·Gₐᵢᵣ(s)
wherein the transfer function for the fuel gas channel is G_{f_g}(s), and the transfer function for the fuel oil channel is G_{f_o}(s).

9. A computer-readable medium for storing computer instructions, wherein when the computer instructions are executed, the method for maintaining stable combustion of a gas turbine during a dynamic process of claim 1 is performed.

10. A gas turbine control system, comprising a memory and a processor, wherein the memory stores computer instructions executable on the processor, and when the processor executes the computer instructions, the method for maintaining stable combustion of a gas turbine during a dynamic process of claim 1 is performed.
